(19) United States
(12) Patent Application Publication
(10) Pub. No.: US 2008/0217873 A1
(43) Pub. Date: Sep. 11, 2008

(54) Vehicle Chassis

(76) Inventors: Christian Feuchtner, Muenchen (DE); Clemens Krueger, Dachau (DE)

Correspondence Address: JORDAN AND HAMBURG LLP, 122 EAST 42ND STREET, SUITE 4000, NEW YORK, NY, 10168, US

(21) Appl. No.: 10/585,767

(22) PCT Filed: Feb. 23, 2005
(86) PCT No.: PCT/EP05/01852

§ 371 Date: Oct. 16, 2006

(30) Foreign Application Priority Data
Mar. 22, 2004 (DE) 10 2004 014 336.6

(51) Int. Cl. B60G 17/02

(52) U.S. Cl. 280/5.515

(57) ABSTRACT

A vehicle chassis comprises a spring support for supporting a bodywork spring that is braced between two spring plates, and a vibration damper which is provided with a piston rod and a damper pipe and in which an area of the piston rod and/or the damper pipe is arranged inside the bodywork spring. At least one spring plate can be axially displaced by means of a drive unit encompassing a driving mechanism and a gear mechanism. The objective is to operate the vehicle chassis such that the energy consumption is low. In particular, the objective is not to use any energy to retain the adjustable spring plate in the mounted position when the vehicle chassis is in the neutral position. This objective is achieved by providing at least one energy store which is effective between the vehicle body and the spring plate and absorbs the weight of the vehicle.

The invention relates to a vehicle chassis of the introductory portion of claim 1.

Such a vehicle chassis is known, for example, from the DE 10101694C1, for which the driving mechanism, with which the spring plate can be shifted axially, is constructed as a worm gear spindle. A worm gear spindle is constructed between a spindle nut, which is constructed as a rotor of an electromagnetic driving mechanism and moved rotationally by means of a ring-shaped stator, when the latter is acted upon with current, and as a spring plate with an external thread corresponding to the thread of the spindle nut. The weight of the vehicle rests on the spring plate, over which it is introduced into the worm gear spindle, which, in turn, exerts a torque on the spindle nut. This also takes place in the non-operative state of the vehicle chassis, in which the spring plate is in the so-called designed state. Due to the weight of the vehicle, a permanent torque acts on the spindle nut and, if it is not counteracted, would twist the spindle nut and, accordingly, shift the spring plate. Therefore, in the non-operative state, it is necessary to act on the adjusting driving mechanism with a permanent holding current, which is large enough to counteract the torque exerted on the worm gear spindle by the weight of the vehicle and to keep the spring plate in its non-operative position (designed state).

Theoretically, admittedly, it would be possible to construct the worm gear spindle self-locking, so that the weight of the vehicle produces self-locking in the worm gear spindle. In this way, it would be possible to do without the permanent generation of a torque, which acts on the spindle nut and counteracts the torque acting on the worm gear spindle because of the weight of the vehicle. In practice, however, such as self-retaining worm gear spindle cannot be realized, because the efficiency of the worm drive would then be too low. Moreover, a driving mechanism of greater power would then be required, in order to obtain the same shifting power as in the case of a worm drive with a better efficiency.

It is an object of the invention to develop a vehicle chassis of the introductory portion of claim 1 in such a manner, that it is possible to do without the permanent introduction of energy (for example, in the form of a holding current) into the adjusting driving mechanism of the spring plate, especially also during the non-operative state of the vehicle chassis, so that less energy is expended. At the same time, it is also to be ensured that the overall height axially of the vehicle chassis is as low as possible.

For a vehicle chassis of the introductory portion of claim 1, this objective is accomplished owing to the fact that at least one energy accumulator, which absorbs the weight of the vehicle, is provided between the vehicle body and the spring plate.

Due to the inventive absorption of the weight of the vehicle by the energy accumulator, it is achieved that a gear mechanism, optimized with respect to its efficiency, such as a worm gear without self-locking properties or a planetary traction drive, can be used without having to introduce energy (holding current) into the adjusting driving mechanism in the non-operative state of the chassis, in order to keep the spring plate in the intended non-operative position (designed state). Owing to the fact that the energy accumulator absorbs the weight of the vehicle in the designed state, the gear mechanism (such as a worm gear) is relieved of this weight. Owing to this relief of load, the spring plate is essentially force free in the designed state (non-operative state of the vehicle), because two forces, which are equal in magnitude and opposite in direction and result from the weight of the vehicle, act on the spring plate. These forces, which are equal in magnitude and opposite in direction, are transferred to the spring plate, on the one hand, by the bodywork spring and, on the other, by the energy accumulator. As a result, the spring plate in the designed state is in a force equilibrium, so that, when the vehicle is in the non-operative state or driving undisturbed in a straight direction, a holding current, with which the spring plate is held in the non-operative state, is not required.

Preferably, the gear mechanism is constructed as a worm gear. A space-saving and reliable control drive for the spring plate can be realized in this way. With respect to its thread pitch, the worm gear can be designed so that it has an optimum efficiency.

In a preferred embodiment of the invention, the energy accumulator is constructed as a spring. Different spring constructions can be used here. For example, it is possible to construct the energy accumulator as a conical helical spring. Such a conical helical spring, under compressive pretension, is integrated into the vehicle chassis in such a way, that it is braced and acts between the body of the vehicle and the spring plate. On its one side, the conical helical spring is supported at the body of the vehicle and, on the other, at the spring plate. Moreover, the spring is dimension and designed so that it takes up the weight of the vehicle body and, at the same time, is compressed by a certain, specified amount. The use of a conical helical spring has the advantage that especially the axial overall height of the chassis can be kept low, because the coils of this spring are pushed into one another when compressed. Such springs therefore have very small block dimensions.

In a different embodiment of the invention, the energy accumulator, constructed as a spring, is formed as a tension spring. In the designed state, the tension spring is stretched under tension between the vehicle body and the spring plate. For this variation, the tension spring is also dimensioned and designed so that it absorbs the weight of the vehicle body.

Admittedly, the tension spring may be constructed as a single spring. However, it is also possible to absorb the weight of the vehicle by several individual tension springs, which are disposed over the periphery of the spring plate.

In practice, it has proven to be advantageous to use an electromagnetic driving mechanism as driving unit and a worm gear, which is driven by this electromagnetic driving mechanism, for shifting the spring plate. The driving mechanism comprises a ring-shaped stator, which carries the windings of an electromagnetic coil, and a rotor, which is also constructed ring-shaped and is enclosed at least partially by the stator. When acted upon with current, the stator exerts a torque on the rotor in a known manner. The ring-shaped rotor is constructed as a spindle nut, that is, at its inner ring surface, it has roll bodies, which interact with a corresponding external thread of the spring plate, so that a worm gear (ball screw spindle) is realized. The external thread advantageously may be applied on the casing surface of a cylindrical continuation of the spring plate, which extends in the axial direction.

Advantageously, the energy accumulator, which absorbs the weight of the vehicle, is disposed within a housing. In this connection, one end of the housing is supported with respect to the vehicle body, whereas the other end is supported directly or indirectly against the spring plate. The piston rod of the suspension damper is connected over a damper bearing with the end of the housing supported at the vehicle body. In the case of such a built-in arrangement of the energy accumulator, the latter, as well as the drive unit, are protected against contamination and water spray, so that an increased functional reliability of the arrangement is achieved.

In the following, the invention is explained in greater detail by means of a drawing, in which

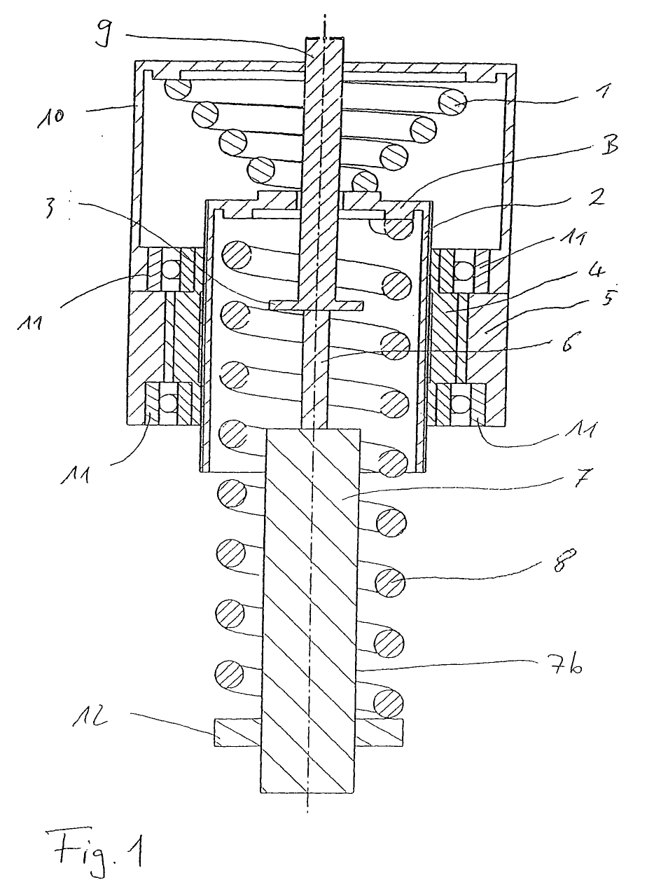

FIG. 1 shows a first embodiment of the invention, for which the energy accumulator is constructed as a conical helical spring,

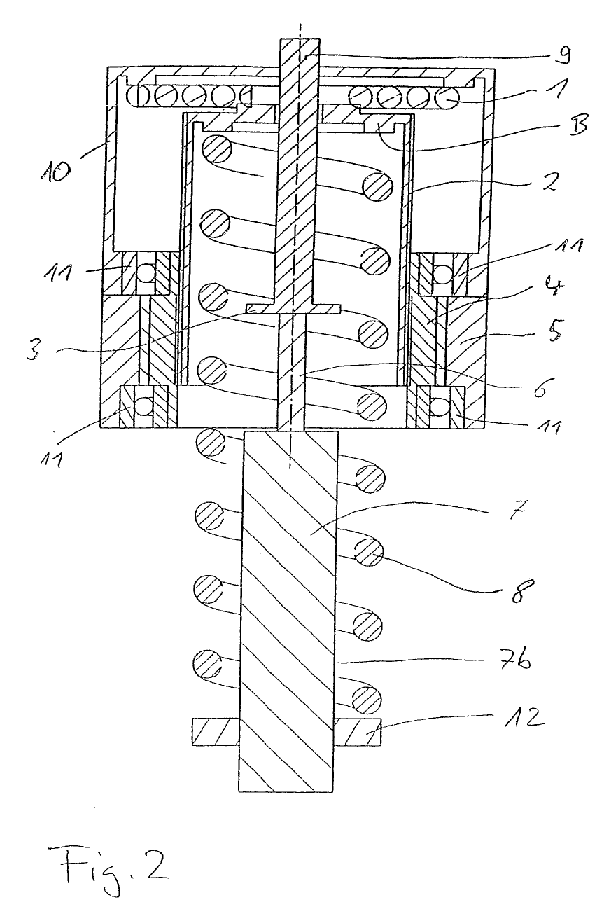

FIG. 2 shows an embodiment of FIG. 1, the spring plate being in a maximum adjusted position and

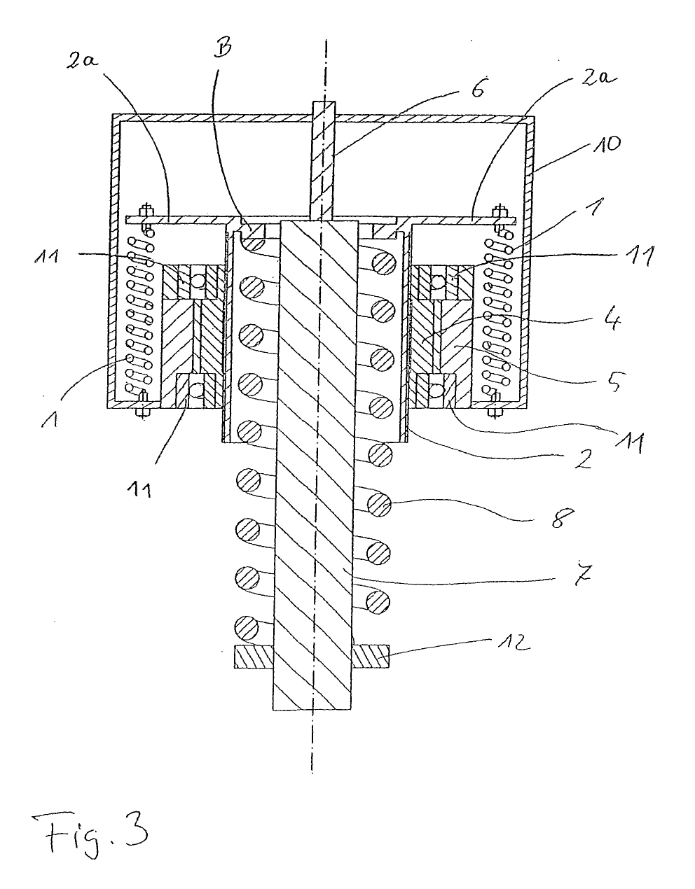

FIG. 3 shows a second embodiment of the invention, for which the energy accumulator is formed by several individual tension springs.

FIG. 1 shows a portion of the chassis of a vehicle. The vehicle chassis comprises a suspension damper 7 with a damper pipe 7b and a piston rod 6. A piston rod extension 9, which is connected firmly with the housing 10, is provided at the piston rod 6. The piston rod extension 9 is tied to the vehicle body. The suspension damper 7, as well as the piston rod 6 extends at least regionally within the bodywork spring 8, which is constructed as a helical spring. In its upper region, the bodywork spring 8 is enclosed by a sleeve-shaped spring plate 2. At its head, the spring plate 2 has a base B, which has an inner surface, disposed in the interior of the sleeve-shaped spring plate 2, and an outer surface, which is opposite to the inner surface. The upper end of the bodywork spring 8 is supported on the inner surface of the base B. On the other hand, the stress-relieving spring 1, which is constructed as a conical, helical spring, is supported at one end on the outer surface of the base B and, at the other, again at an inner surface of a housing 10, which is connected over the piston rod extension 9 with the vehicle body.

A stator 5, which is constructed as an electromagnetic coil, is provided as driving mechanism. This ring-shaped stator 5 encloses a rotor 4, which is constructed as a spindle nut and forms the rotor of the electromagnetic driving mechanism. The rotor 4 is mounted so that it can rotate over the ball bearing 11 relative to the stator 5. The cylindrical inner surface of the rotor 4 has an internal thread, so that the rotor 4 can be used as a spindle nut. There is an external thread, which corresponds to the (not shown) roll bodies of the spindle nut 4, on the outer casing of the cylindrical section of the sleeve-like spring plate 2, which extends in axial direction. In this way, the spindle nut 4 forms a worm gear with the spring plate 2.

With the end, which is the upper end in FIG. 1, the housing 10 is supported with respect to the vehicle body and with the end, which is the lower end in FIG. 1, it is supported at the stator 5 and, with that, indirectly at the spring plate. In the non-operative state of the vehicle or when it is traveling steadily straight ahead, the weight of the vehicle body acts over the housing 10 directly on the stress-relieving spring 1, which absorbs this weight. The stress-relieving spring 1 is dimensioned and designed appropriately for this purpose.

This weight is transferred over the stress-relieving spring 1 to the spring plate 2. On the side opposite to the stress-relieving spring, the upper end of the bodywork spring 8 is supported at the spring plate 2. With its lower end, the bodywork spring 8 is supported at the spring plate 12, which is connected firmly with the suspension damper pipe 7b. Accordingly, the bodywork spring 8 also absorbs the weight of the vehicle in the non-operative state (designed state). Two forces of equal magnitude and opposite direction, namely, on the one hand, the compressive force of the stress-relieving spring 1 (which acts in the direction away from the vehicle body) and, on the other, that of the body spring 8 (which acts in the direction of the vehicle body), act in this way in the designed state on the spring plate 2. These forces are equal with respect to their magnitude. As a result, the spring plate 2 is held in a force equilibrium in the designed state. No force, producing an adjusting moment on the rotor 4, is acting on the worm drive in this state, so that it is not necessary to introduce a holding current, with which the spring plate is held in the designed state, into the drive unit 4, 5. Accordingly, the inventive chassis makes do with a less the expenditure of energy than the chassis known from the prior art, for which a corresponding holding current is required.

Starting out from the designed state (non-operative state), the spindle nut 4 can now be rotated by acting on the stator 5 with current, so that the worm gear becomes effective and adjusts the spring plate in the desired and known manner.

FIG. 2 shows the chassis of FIG. 1 with the position of the spring plate 2 changed from that of FIG. 1. In FIG. 2, the spring plate 2 has been moved to the outermost adjusted position, the stress-relieving spring 1 being compressed to the maximum extent. The individual coils of the stress-relieving spring 1, formed as a conical helical spring, are pushed into one another in this position, so that the block dimensions of this spring correspond simply to the diameter of the wire. Due to this construction, a particularly small overall axial height of the adjustable shock-absorbing strut arrangement and, with that, of the whole system of the chassis is achieved.

The inventive, active, shock-absorbing strut arrangements require an overall axial height, which is only slightly larger than that of the passive shock-absorbing strut arrangements. Existing, passive shock-absorbing struts (that is, shock absorbing struts not equipped with adjustable spring plates) can be replaced pursuant to the invention by active, electromechanical shock-absorbing struts without further reconstruction measures. By these means, passenger cars with conventional non-active chassis, can be retrofitted correspondingly with active chassis.

A different embodiment of the invention is shown in FIG. 3. For this embodiment, the stress-relieving spring 1 is formed by several tension springs, which are disposed distributed along the periphery of the spring plate 2. The tension springs are fastened with their one end to the end of the housing 10 averted from the piston rod 6 of the suspension damper 7 and, with their other end, to a collar 2a of the spring plate 2.

For this embodiment also, the piston rod 6 is connected over a shock-absorbing bearing with the housing 10. The weight of the vehicle body acts over the piston rod 6 on the housing 10, so that this weight is introduced over the housing 10 into the tension springs. The tension springs are dimensioned and designed so that they absorb this weight.

The tension springs transfer this weight to the spring plate 2. As a result, a force, directed away from the vehicle body and introduced over the spring plate 2 into the bodywork spring 8, acts on the spring plate 2. The bodywork spring 8 is disposed as already described above in connection with FIG. 1. A force, which is directed to the vehicle body and has the same magnitude as the resultant of the forces acting from the individual tension springs on the spring plate 2, is transferred by the bodywork spring 8. Accordingly, since the forces acting on the spring plate 2 once again are equal in magnitude and opposite in direction, the spring plate 2 in the designed state is kept in a force equilibrium. As already explained in connection with FIG. 1, no force, which would be transfer a torque to the rotor 4, is acting in this state in the worm gear. For this embodiment also, there is therefore no need for introducing a holding current.

It is self-evident that the inventive teachings can be used for all shock-absorbing struts with adjustable spring plates, for which the driving unit for adjusting the spring plate is configured so that the weight of the vehicle body produces a force or a torque in the designed state, which would bring about an adjustment of the spring plate and for which therefore energy (for example, in the form of a holding current) must be expended in order to counteract this undesirable shifting. In this respect, the worm gears, shown in the Figures of the examples and formed by internal and external threads, are to be regarded only as examples. The driving mechanism can likewise be constructed as ball screw spindles. The gear mechanisms may, for example, also be constructed as planetary traction drives. Other electromechanical or hydraulic driving mechanisms are also conceivable as adjusting driving mechanisms. The inventive teachings can also be used successfully for these adjusting driving mechanisms.

### LIST OF REFERENCE SYMBOLS

1 stress-relieving spring
2 spring plate
2a collar
3 damper stop
4 rotor, spindle nut
5 stator
6 piston rod
7 suspension damper
7b damper tube
8 bodywork spring
9 piston rod extension
10 housing
11 ball bearing
12 spring plate
B base
G gear mechanism

1. Vehicle chassis comprising a spring support for supporting a bodywork spring, stretched between two spring plates, and a suspension damper, which has a piston rod and a damper tube and for which a region of the piston rod and/or of the damper tube is disposed within the bodywork spring, at least one spring plate being axially adjustable by means of a driving unit comprising a driving mechanism and a gear mechanism, least one energy accumulator, which absorbs the weight of the vehicle and acts between the vehicle body and the spring plate to relieve the load on the driving unit.

2. The vehicle chassis of claim 1, wherein the gear mechanism is constructed as a worm gear.

3. The vehicle chassis of claims 1 or 2, wherein the energy accumulator is constructed as a spring.

4. The vehicle chassis of claim 3, wherein the spring is a conical, helical spring, which is braced under pressure between the vehicle body and the spring plate.

5. The vehicle chassis of claim 3, wherein the spring is a tension spring which is stretched under tension between the vehicle body and the spring plate.

6. The chassis of claim 5, wherein the tension spring comprises several individual tension springs disposed distributed over the periphery of the spring plate.

7. The chassis of claims 1 or 2, wherein the driving mechanism is an electromagnetic driving mechanism which comprises a ring-shaped stator and, enclosed by the latter at least partially, a ring-shaped rotor.

8. The chassis of claims 2 or 7, wherein the rotor is constructed as a spindle nut, which has an internal thread at its inner ring surface, the internal thread acting together with an external thread present at a cylindrical continuation of the spring plate in order to form the worm gear.

9. The vehicle chassis of claim 7, wherein the energy accumulator is disposed within a housing, one end of the housing being supported at the vehicle body and the other at the stator.
